(19) United States
(12) Patent Application Publication
(10) Pub. No.: US 2006/0103624 A1
(43) Pub. Date: May 18, 2006

(54) Image display apparatus, electronic apparatus, and image display method

(75) Inventors: Fumiaki Ishito, Osaka (JP); Takae Yasuda, Osaka (JP); Hiroshi Mashima, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/223,626

(22) Filed: Sep. 9, 2005

(30) Foreign Application Priority Data
Nov. 16, 2004 (JP) 2004-331977

(51) Int. Cl. G09G 5/00

(52) U.S. Cl. 345/156

(57) ABSTRACT

When an electronic book 1 momentarily moves by Δy in the direction of the arrow A because of a vibration, an image display 7 (an LCD module 15) is changed downward by Δy so that when the user is viewing an image, the user's line of sight is substantially fixed like when there is hardly any vibration on the electronic book 1. By performing such an operation in each of the X axis and Y axis directions, the relative position of the display image in the direction of the X axis with respect to the user's line of sight because of a vibration in the X axis direction (the direction of an arrow D) of the image display 7 (the LCD module 15) is made fixed, and the relative position of the display image in the direction of the Y axis with respect to the user's line of sight because of a vibration in the direction of the Y axis (the direction of an arrow C) of the image display 7 (the LCD module 15) is made fixed.

This application is based on applications No. 2004-331977 filed in Japan, the content of which is hereby incorporated by reference.

### BACKGROUND OF THE INVENTION

1. Field of the Invention

The present invention relates to an image display apparatus provided with a display screen for displaying images, an electronic apparatus, and an image display method.

2. Description of the Related Art

In recent years, a display apparatus, so-called an electronic book, has been known where a recording medium (for example, a CD-ROM or an MD) on which information (contents) such as texts, images, sounds and the like of books are digitally recorded is detachably attachable and when the recording medium is attached, the contents recorded on that recording medium are displayed on a display such as an LCD (liquid crystal display).

In addition to the electronic book, various portable electronic apparatuses capable of displaying various images and texts have been known and used.

Such an electronic book and electronic apparatuses are sometimes used, for example, on a train or in a vehicle. Under such circumstances, a vibration (shake) occurs on the user of the electronic book or the like or on the electronic book or the like itself because of the running of the train or the like, so that it is frequently difficult for the user to read the contents displayed on the electronic book because of the vibration or the like occurring on the electronic book.

### SUMMARY OF THE INVENTION

The present invention is made in view of the above-mentioned circumstances, and an object thereof is to provide an image display apparatus, an electronic apparatus and an image display method in which the viewability is excellent even under circumstances where a vibration occurs on the user of the apparatus or on the apparatus.

To solve the above-mentioned object, a first aspect of the present invention provides an image display apparatus provided with: a display that displays an image; a first detector that detects a vibration provided to the image display apparatus; and a display controller that moves a display position of the image displayed on the display in a direction opposite to a direction of a motion of the image display apparatus which motion constitutes the vibration detected by the first detector.

According to this structure, when a vibration provided to the image display apparatus or the display is detected, the display position of the image displayed on the display screen of the display is moved in a direction opposite to the direction of the motion of the image display apparatus which motion constitutes the detected vibration. Consequently, when the user of the image display apparatus is viewing an image displayed on the display, even if a vibration is provided to the image display apparatus or the display, it is unnecessary for the user to move the line of sight, or the required movement amount of the line of sight is reduced.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a view showing the external structure of an electronic book;

FIG. 2 is a perspective view schematically showing the structure of a driving mechanism;

FIGS. 3A and 3B are views for explaining the driving of an image display;

FIG. 4 is a block diagram showing the electrical structure of the electronic book;

FIG. 5 is a flowchart showing a series of driving processing by the electronic book of the first embodiment;

FIG. 6 is a block diagram showing the electrical structure of an electronic book in a modification;

FIGS. 7A and 7B are views for explaining the movement of the image display position; and

FIG. 8 is a flowchart showing a series of display processing by the electronic book shown in FIG. 6.

### DETAILED DESCRIPTION OF THE PREFERRED EMBODIMENTS

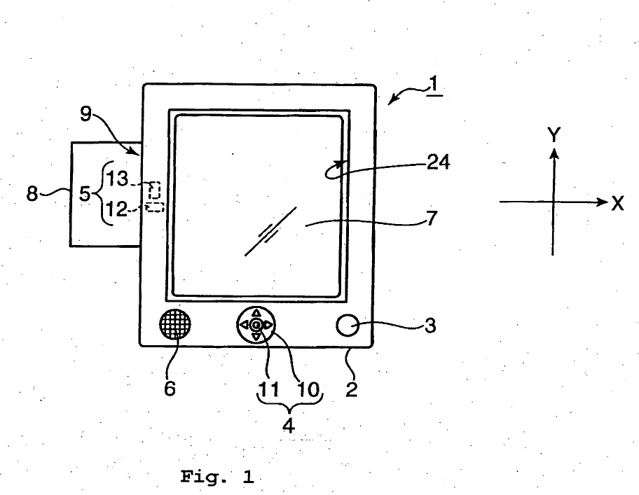

Hereinafter, an electronic book as an example of the electronic apparatus provided with an image display apparatus will be described. First, the external structure of the electronic book will be described with reference to FIG. 1.

As shown in FIG. 1, the electronic book 1 has a power switch 3, an operation key 4, a vibration detection sensor 5, a sound output portion 6 and an image display 7 in a body 2. The image display 7 is disposed substantially in the center of the front surface of the body 2. The power switch 3, the operation key 4 and the sound output portion 6 are arranged in the horizontal direction below the image display 7.

The body 2 has a rectangular parallelepiped shape, and a slot 9 for setting a subsequently described recording medium 8 in the body 2 is formed on one side surface of the body 2. The slot 9 is a loading opening for loading the recording medium 8. While the recording medium 8 inserted in the slot 9 is an MD (mini disc) in the present embodiment, the present invention is not limited thereto. It may be a disc-shaped recording medium such as a DVD (digital versatile disc), a CD-ROM (compact disk read-only memory) or an MO (magneto-optic disc), or a flash memory card medium such as a CF (compact flash) card or an SD memory card, and the kind thereof is not limited. On these recording media, text data, image data, sound data and the like are recorded.

The power switch 3 is provided for turning on and off the main power of the electronic book 1.

The operation key 4 is provided with: a four-way key 10 having an annular member provided with a plurality of depression portions (triangular parts in the figure) disposed at regular intervals in the circumferential direction; and a central button 11 disposed in the center of the four-way key 10. Non-illustrated contacts are provided so as to correspond to the depression portions of the four-way key 10 and the central button 11, and the depression of the depression portions and the like is detected by the contacts.

The four-way key 10 and the central button 11 have, for example, a function of inputting an instruction to display the contents recorded on the recording medium 8 set in the slot 9, a function of inputting an instruction to perform the page switching of the displayed contents to the next page or to the previous page, and a function of inputting an instruction to start the display at a desired page (hereinafter, this instruction will be referred to as a bookmarking instruction) when the contents on the recording medium 8 are displayed next time, that is, a function similar to a bookmark used by being put between pages of a book.

Instead of the four-way key 10 and the central button 11, a combination of a jog dial and a push button may be used. Moreover, the function of a push button can be provided by depressing the jog dial itself.

The vibration detection sensor 5 detects vibrations occurring on the electronic book 1, and as shown in FIG. 1, has an X sensor 12 that detects vibrations in the direction of the X axis and a Y sensor 13 that detects vibrations in the direction of the Y axis when a two-dimensional coordinate system is set in which the direction horizontal with respect to the display screen of the image display 7 is the X axis and the direction vertical thereto is the Y axis. The X sensor 12 and the Y sensor 13 each have an acceleration sensor that detects the acceleration of the vibration in each direction.

The sound output portion 6 outputs a sound such as the operation sound when the power switch 3, the operation key 4 or the like is operated. Moreover, the present embodiment has the function of outputting the text displayed on the image display 7 as voice, and the sound output portion 6 outputs this voice. Not only the voice of a text but also music contents can be played back.

The image display 7 displays the contents stored on the recording medium 8, and comprises, for example, an LCD (liquid crystal display). The image display 7 is not limited to an LCD but may be an organic EL or a plasma display.

In the electronic book 1 of the present embodiment, the image display 7 is structured so as to be driven in the directions of the X and Y axes by a driving mechanism 14 described below.

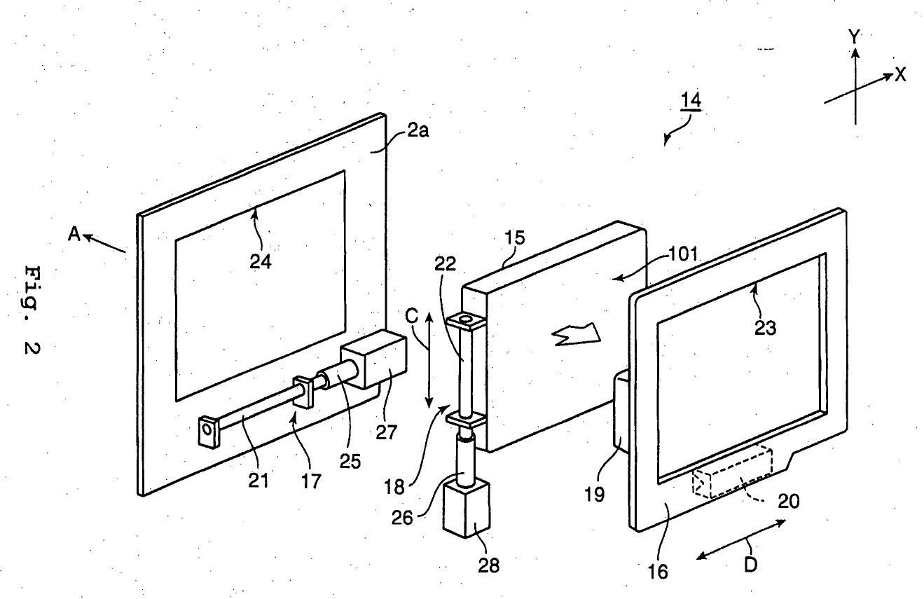

Next, the structure of the driving mechanism 14 will be described with reference to FIG. 2. The X and Y axes in this figure correspond to the X and Y axes shown in FIG. 1, and the direction shown by the arrow A corresponds to the direction toward the front in FIG. 1.

As shown in FIG. 2, when a vibration is caused on the electronic book 1, the driving mechanism 14 moves (swings) the image display 7 as appropriate in accordance with the vibration to thereby reduce a movement of the display image with respect to the line of sight of the user of the electronic book 1.

The driving mechanism 14 is provided with an LCD module 15, a slider 16 holding the LCD module 15, an X axis actuator 17, and a Y axis actuator 18.

The LCD module 15 is provided with a liquid crystal panel, a back light, and a driving circuit. The Y axis actuator 18 is disposed on one side in the horizontal direction (the left side in the figure) of the LCD module 15. The LCD module 15 is attached so as to be slidable on the slider 16 in the direction of the Y axis (the direction shown by the arrow C in FIG. 2) through the Y axis actuator 18.

The slider 16 is a substantially flat-shaped frame member having an opening 23 substantially in the center thereof. A bearing 19 where a V-groove slidably engaging with the Y axis actuator 18 (a shaft 22 described later) is formed to enable the above-mentioned sliding is fixedly provided in a position of the slider 16 that is opposed to the Y axis actuator 18.

Moreover, a bearing 20 corresponding to the X axis actuator 17 and structured similarly to the bearing 19 is fixedly provided in a lower part of the slider 16. The engagement (frictional coupling) of the shafts 22 and 21 with the bearings 19 and 20 is achieved by sandwiching the shafts 22 and 21 between non-illustrated presser plates (a presser plate for the X axis and a presser plate for the Y axis) and the bearings 19 and 20 by a pushing force by a non-illustrated pushing member such as a spring.

A body frame 2a serving as the base for holding the slider 16 is a frame member in which a rectangular opening 24 larger than the LCD module 15 is formed substantially in the center thereof. The X actuator 17 is fixedly provided on a side in the vertical direction (as an example, the lower side) of the body frame 2a. The slider 16 is attached to the body frame 2a so that the bearing 20 of the slider 16 is slidable in the direction of the X axis (the direction shown by the arrow D in FIG. 1) in a condition of being slidably engaged with the X axis actuator 17 (the shaft 21).

The opening 24 has a size such that the display screen of the LCD module 15 is not obstructed by the frame part defining the opening 24 when the LCD module 15 is driven in the directions of the X and Y axes.

The X axis actuator 17 and the Y axis actuator 18 are impact linear actuators (piezoelectric actuator) where ultrasonic driving is performed. These actuators comprise the shafts 21 and 22, piezoelectric elements 25 and 26 and weights 27 and 28, respectively. The shafts 21 and 22 are bar-shaped driving shafts driven by the piezoelectric elements 25 and 26, respectively, and having a predetermined cross-sectional shape, for example, a circular shape, and are frictionally coupled to the bearings 20 and 19, respectively.

The piezoelectric elements 25 and 26 which are made of ceramics or the like expand and contract according to the applied voltage, and vibrate the shafts 21 and 22 according to the expansion and contraction. In the expansion and contraction by the piezoelectric elements 25 and 26, high-speed expansion and low-speed contraction are alternately repeated or low-speed expansion and high-speed contraction are alternately repeated in accordance with the direction in which the LCD module 15 and the slider 16 are to be driven. When the LCD module 15 and the slider 16 are made stationary, expansion and contraction of the same speed are alternately repeated. The piezoelectric elements 25 and 26 comprise, for example, stacked piezoelectric elements, and are fixed to one ends of the shafts 21 and 22 so that the polarization direction coincides with the axial directions of the shafts 21 and 22.

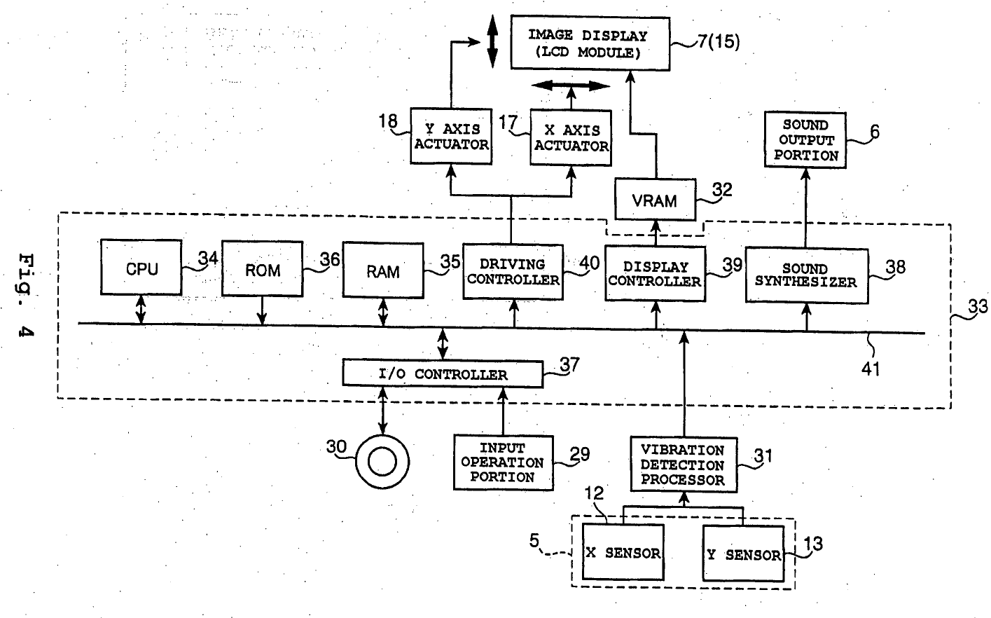

A signal line from a general controller 33 described later (see FIG. 4) is connected to the electrodes of the piezoelectric elements 25 and 26, and the above-mentioned expansion and contraction are performed by the piezoelectric elements 25 and 26 being charged or discharged (charged in the opposite direction) in response to a driving signal from the general controller 33. By the piezoelectric elements 25 and 26 thus repeating expansion and contraction, the bearing 20, that is, the slider 16 relatively moves in the normal or opposite direction with respect to the shaft 21 or the bearing 22 relatively moves in the normal or opposite direction with respect to the bearing 19, or these members stop in those positions.

The weights 27 and 28 for enabling the vibration caused by the piezoelectric elements 25 and 26 to be efficiently transmitted to the shafts 21 and 22 are fixedly provided at the ends of the piezoelectric elements 25 and 26 that are opposite to the shafts 21 and 22.

In this structure, according to the present embodiment, the X axis actuator 17 is driven so as to cancel out (offset) the vibration in the direction of the X axis detected by the X sensor 12 of the vibration detection sensor 5, and the Y axis actuator 18 is driven so as to cancel out (offset) the vibration in the direction of the Y axis detected by the Y sensor 13.

That is, in FIG. 1, for example, when the electronic book 1 moves by Δx rightward in the direction of the X axis because of the vibration, a driving controller 40 described later (see FIG. 4) moves the LCD module 15 by the movement amount Δx leftward in the direction of the x axis, and when the electronic book 1 moves by Δy upward in the direction of the Y axis because of the vibration, the driving controller 40 moves the LCD module 15 by the movement amount Δy downward in the direction of the Y axis.

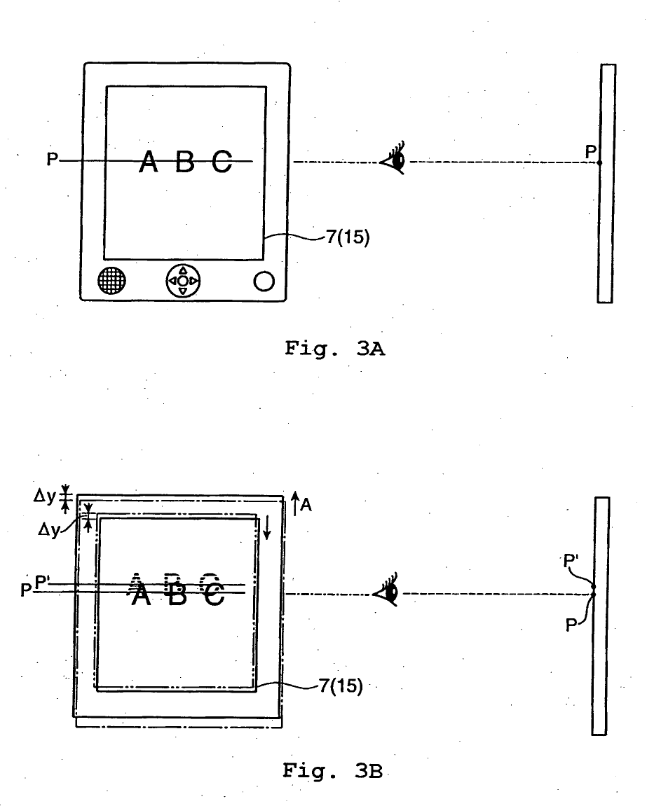

For example, it is assumed that letters “ABC” are displayed in a position denoted by “P” in the direction of the Y axis of the image display 7 as shown in FIG. 3A when there is hardly any vibration on the electronic book 1. And it is assumed that the electronic book 1 momentarily moves by Δy in the direction of the arrow A because of the vibration as shown in FIG. 3B. The chain line of FIG. 3B shows the position of the electronic book 1 shown in FIG. 3A, and the chain double-dashed line shows the position of the image display portion 7 when the electronic book 1 momentarily moves by Δy in the direction of the arrow A in a case where the image display 7 (the LCD module 5) is not driven. For the viewability of the drawing, the power switch 3 and the like are not shown in FIG. 3B.

Even if a vibration is caused on the electronic book 1, when the image display 7 (the LCD module 15) is not driven, the letters “ABC” move from the position denoted by “P” shown in FIG. 3B to the position denoted by “P′.” In this case, it is necessary for the user to move the line of sight in response to the movement, and when the movement amount (corresponding to the amplitude of the vibration) of the image which is the object of viewing is comparatively large, it is necessary to largely move the line of sight and this becomes a cause of eye fatigue. Moreover, even in a case where the movement amount (amplitude) of the image which is the object of viewing is comparatively small, when the frequency thereof is comparatively high, the movement of the line of sight does not catch up with the movement (swing) of the display image, so that the image displayed on the image display 7 is viewed being blurred. In any case, excellent viewability of the electronic book 1 cannot be secured.

On the contrary, according to the present embodiment, as shown by the solid line of FIG. 3B, when the electronic book 1 momentarily moves by Δy in the direction of the arrow A because of a vibration, the image display 7 (the LCD module 15) is moved downward by the movement amount Δy. This makes the user's line of sight substantially fixed (the position denoted by “P”) like in the case of FIG. 3A.

By performing this operation in each of the directions of the X and Y axes, the relative position of the display image in the direction of the X axis with respect to the user's line of sight by a vibration of the image display 7 (the LCD module 15) in the direction of the X axis (in the direction of the arrow D) is fixed, and the relative position of the display image in the direction of the Y axis with respect to the user's line of sight by a vibration of the image display 7 (the LCD module 15) in the direction of the Y axis (the direction of the arrow C) is fixed. Consequently, even if a vibration occurs on the electronic book 1, excellent viewability of the electronic book 1 can be secured.

Next, the electrical structure of the electronic book 1 will be described with reference to FIG. 4.

As shown in FIG. 4, the electronic book 1 is provided with a vibration detection sensor 5, an image display 7, an input operation portion 29, an image storage 30, a vibration detection processor 31, a VRAM 32, a sound output portion 6 and a general controller 33.

The vibration detection sensor 5 corresponds to the vibration detection sensor 5 shown in FIG. 1, and is provided with the X sensor 12 and the Y sensor 13. The image display 7 corresponds to the image display 7 shown in FIG. 1. The input operation portion 29 includes the above-mentioned power switch 3 and operation key 4, and is provided for inputting a predetermined instruction to the electronic book 1. The image storage 30 is the above-mentioned recording medium 8 comprising an MD. The image storage 30 is not limited to an MD. It may be a recording medium such as a DVD, a CD-ROM or an MO, or a flash memory card medium such as a CF card or an SD memory card, or may comprise two or more of these media.

The vibration detection processor 31 is provided with: a filter circuit (a low-pass filter and a high-pass filter) for reducing noise and drift from acceleration signals outputted from the X sensor 12 and the Y sensor 13; and an amplifier circuit for amplifying the acceleration signals.

The VRAM 32 which has an image signal storage capacity corresponding to the number of pixels of the image display 7 is a buffer memory for the pixel signals of the image displayed on the image display 7.

The general controller 33 includes a microcomputer, and performs the centralized control of the operation of the electronic book 1 by controlling the driving of the above-mentioned members in the body 2 in association with one another. The general controller 33 is provided with a CPU 34, a RAM 35 for the work of the CPU 34, and a ROM 36 storing programs of various functions provided for the electronic book 1.

Moreover, the general controller 33 is provided with an input and output controller 37, a sound synthesizer 38, a display controller 39, and a driving controller 40. The CPU 34, the RAM 35, the ROM 36, the input controller 37, the sound synthesizer 38, and the display controller 39 perform data transfer with one another through a bus 41.

The input and output controller 37 converts data outputted from the image storage 30 and an operation signal inputted through the input operation portion 29 to a data format processable by the CPU 34 and the like.

The sound synthesizer 38 reads out, of the data recorded on the image storage 30, data associated with a sound through the bus 41, and causes the speaker 6 to output the data as the sound.

The display controller 39 converts the data associated with an image stored on the image storage 30 to image data corresponding to the number of pixels of the image display 7, and causes the image display 7 to display the image data.

The driving controller 40 captures a detection signal from the vibration detection processor 31 at predetermined time intervals, calculates the shift amounts (the amplitude of the vibration) in the X and Y directions of the electronic book 1, converts the amplitude into a movement amount of the image display 7, and controls the driving of the X axis actuator 17 and the Y axis actuator 18 based on the movement amount.

That is, in FIG. 1, for example, when the electronic book 1 moves by Δx rightward in the direction of the X axis, the driving controller 40 moves the image display 7 by the movement amount (amplitude) Δx leftward in the direction of the X axis, and when the electronic book 1 moves by Δy upward in the direction of the Y axis, the driving controller 40 moves the image display 7 by the movement amount (amplitude) Δy downward in the direction of the Y axis.

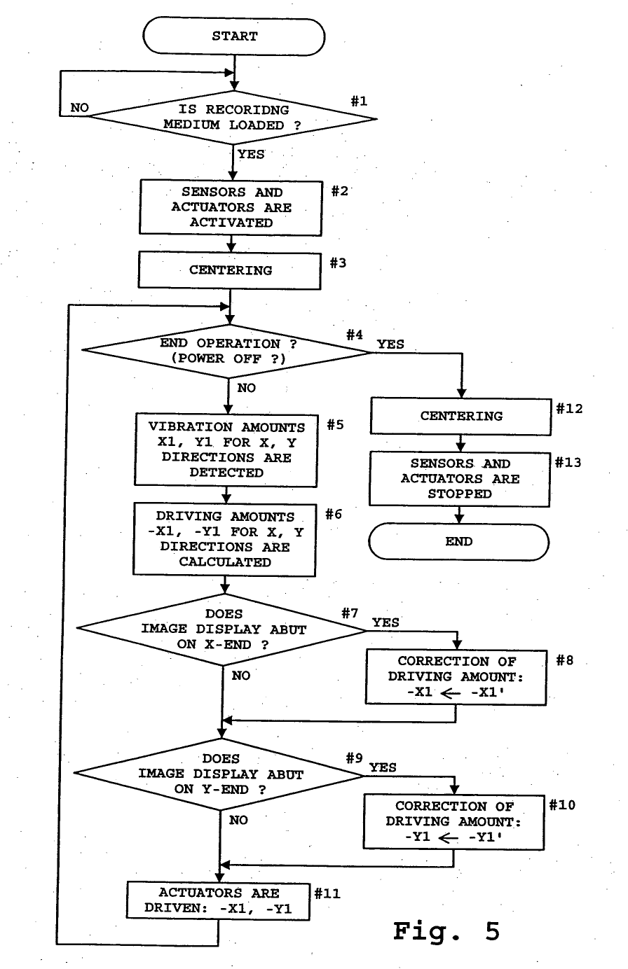

The driving control processing of the image display 7 by the electronic book 1 of the present embodiment will be described with reference to the flowchart of FIG. 5. The electronic book 1 starts this operation when the power switch 3 is turned on.

As shown in FIG. 5, when the recording medium 8 is loaded in the slot 9 (YES at step #1), the general controller 33 starts power supply to the vibration detection sensor 5 (the X sensor 12 and the Y sensor 13), the X axis actuator 17, the Y axis actuator 18 and the vibration detection processor 31 to actuate these members (step #2), and situates the image display 7 in the central position in the movable range of the image display 7 (step #3).

Then, the general controller 33 determines whether the main power is turned off through the power switch 3 or not (step #4). When the main power is not turned off (NO at step #4), the amplitude (X1, Y1) of the vibration occurring on the electronic book 1 is detected (step #5), and the driving amount (−X1, −Y1) of the image display 7 for canceling out the detected amplitude (X1, Y1) is calculated (step #6).

Then, the general controller 33 drives the image display 7 by the calculated driving amount (−X1, −Y1) of the image display 7, and determines whether the image display 7 abuts on an end, in the direction of the X axis, of the opening 24 of the body frame 2a shown in FIG. 2 or not (step #7). When it is determined that it abuts (YES at step #7), the calculated driving amount −X1 in the direction of the X axis is corrected to a driving amount −X1′ for situating the image display 7 in a position where it is situated immediately before abutting on the end (step #8). When it is determined that it does not abut (NO at step #7), the process proceeds to step #9.

After the processing of step #7 or #8, the general controller 33 determines whether the image display 7 abuts on an end, in the direction of the Y axis, of the opening 24 of the body frame 2a shown in FIG. 2 or not (step #9). When it is determined that it abuts (YES at step #9), the calculated driving amount −Y in the direction of the Y axis is corrected to a driving amount −Y1′ for situating the image display 7 in a position where it is situated immediately before abutting on the end (step #10).

Then, the general controller 33 causes the X axis actuator 17 and the Y axis actuator 18 to drive the image display 7 based on the driving amount calculated at step #6 or the corrected driving amount corrected at step #8 or #10 (step #11).

On the other hand, at step #4, when the main power is turned off (YES at step #4), the image display 7 is situated in the central position in the movable range of the image display 7 (step #12), and then, the power supply to the vibration detection sensor 5, the X axis actuator 17, the Y axis actuator 18 and the vibration detection processor 31 is stopped (step #13).

As described above, since the image display 7 is moved by a movement amount substantially the same as the amplitude of the vibration in a direction opposite to the direction of the motion (movement) of the electronic book 1 which motion constitutes the vibration occurring on the electronic book 1, when the user of the electronic book 1 is viewing an image, the display position of the image with respect to the user's line of sight can be maintained substantially fixed, so that excellent viewability can be secured even if a vibration occurs on the electronic book 1.

In addition to the above-described embodiment or instead of the above-described embodiment, modifications described in the following [1] to [7] are also adoptable:

[1] While the viewability of the image display 7 is improved by driving the image display 7 with respect to the vibration occurring on the electronic book 1 in the above-described embodiment, the present invention is not limited thereto. A structure may be adopted such that the image display 7 is stationary and the display position of the image displayed on the image display 7 is moved in accordance to the vibration.

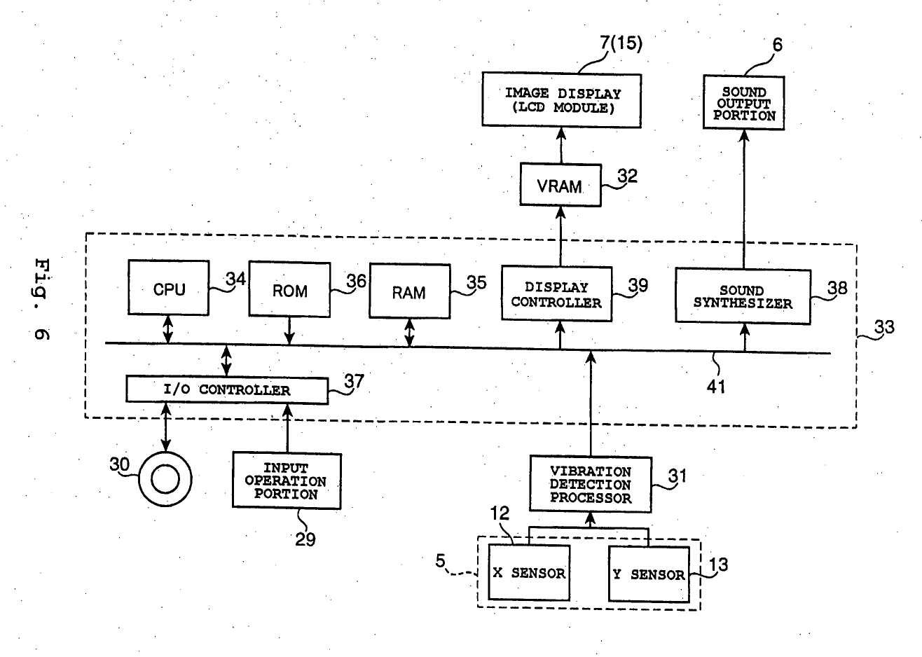

The electric structure of an electronic book 1 in a modification will be described with reference to FIG. 6.

As shown in FIG. 6, the electronic book 1 of this modification is substantially the same as the electronic book 1 of the above-described embodiment except that neither the driving mechanism 14 nor the driving controller 40 is provided because the image display 7 is stationary; however, it is different from the electronic book 1 of the above-described embodiment in that the display controller 39 operates in a subsequently described manner. In FIG. 6, members substantially the same as those shown in FIG. 4 are denoted by the same reference numerals.

In addition to the function of converting data associated with a display image stored on the image storage 30 to image data corresponding to the number of pixels of the image display 7 and causing the image display 7 to display the image data, the display controller 39 captures the detection signal from the vibration detection processor 31 at predetermined time intervals, calculates the amplitude of the vibrations in the directions of the X and Y axes of the electronic book 1, converts the amplitude to the movement amount of the display position of the image, and changes the display position of the image displayed on the image display 7 based on the movement amount.

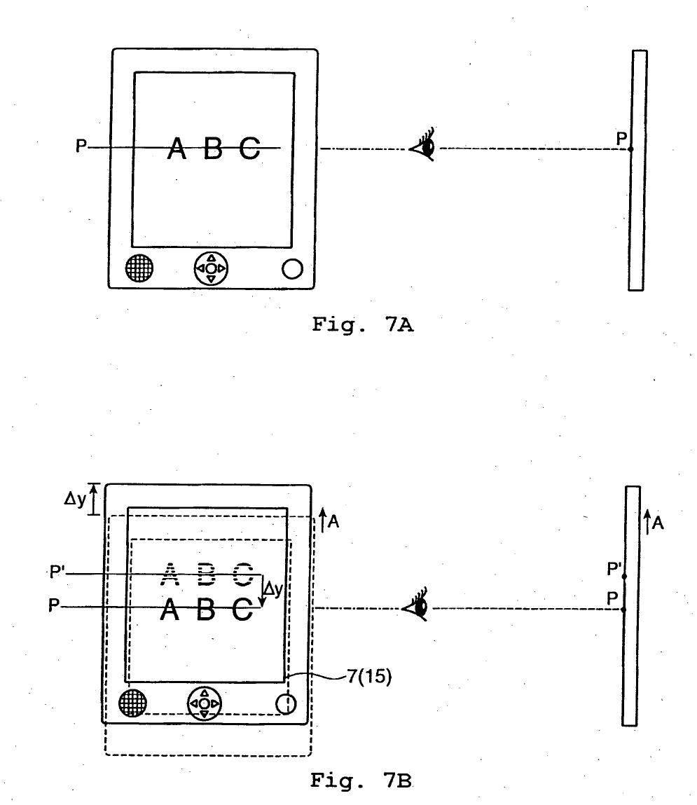

For example, it is assumed that letters “ABC” are displayed in a position, denoted by “P”, of the image display 7 as shown in FIG. 7A when there is hardly any vibration on the electronic book 1. And it is assumed that the electronic book 1 momentarily moves by Δy in the direction of the arrow A because of the vibration as shown in FIG. 7B.

When the image display position is not changed even when a vibration occurs on the electronic book 1, the letters “ABC” are displayed in the position “P1” shown in FIG. 7B, so that excellent viewability of the electronic book 1 cannot be secured for the same reason as that mentioned above.

On the contrary, according to the present modification, as shown in FIG. 7B, when the electronic book 1 momentarily moves by Δy in the direction of the arrow A because of a vibration, the display position of the letters “ABC” is changed downward by the movement amount Δy. This makes the user's line of sight substantially the same as that in the case of FIG. 7A (that is, the position “P”), so that excellent viewability of the electronic book 1 can be secured even when a vibration occurs on the electronic book 1.

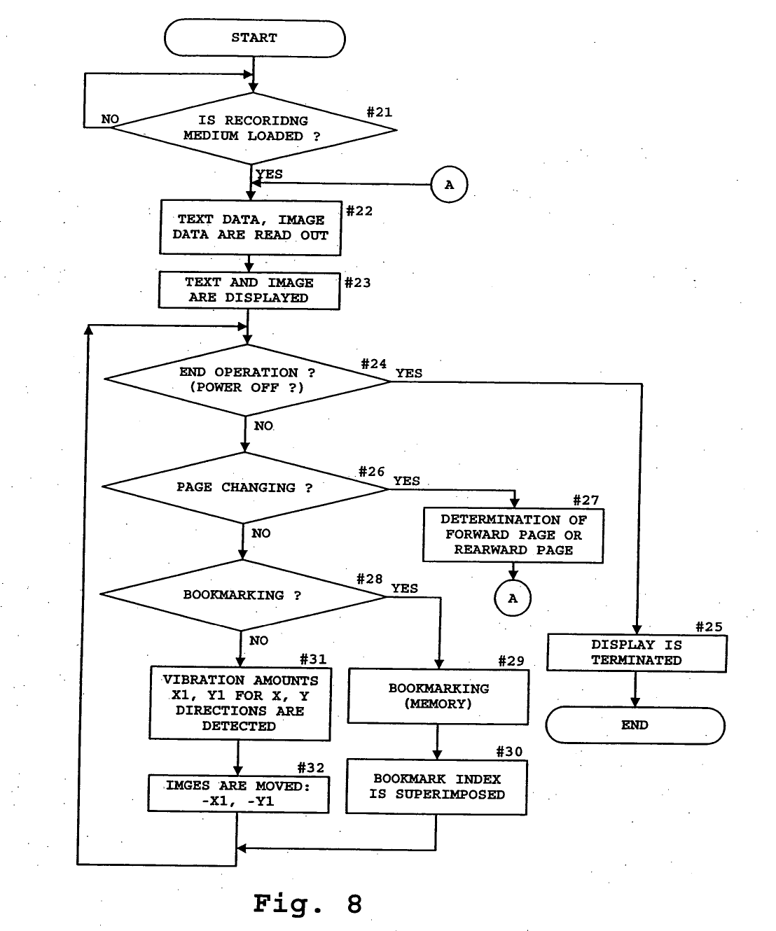

The display control processing by the electronic book 1 of this modification will be described with reference to the flowchart shown in FIG. 8. The electronic book 1 starts this operation when the power switch 3 is turned on.

As shown in FIG. 8, when the recording medium 8 is loaded in the slot 9 (YES at step #21), the general controller 33 reads in text data and image data from the recording medium 8 (step #22), and causes the image display 7 to display the data (step #23). When a bookmarking instruction is provided in the previous display, the bookmarked page is displayed.

Then, the general controller 33 determines whether the main power is turned off through the power switch 3 or not (step #24), and when the main power is turned off (YES at step #24), erases the display of the image on the image display 7 (step #25). On the other hand, when the main power is not turned off (NO at step #24), the general controller 33 determines whether a page switching instruction is provided through the operation key 4 or not (step #26).

When a page switching instruction is provided (YES at step #26), the general controller 33 determines whether the page switching instruction is an instruction to switch to the previous page or to the next page (step #27). Then, returning to step #22, the general controller 33 reads out the data of the page to be displayed from the recording medium 8, and causes the image display 7 to display the data (steps #22 and #23).

Moreover, the general controller 33 determines whether a bookmarking instruction is provided through the operation key 4 or not (step #28). When a bookmarking instruction is provided (YES at step #28), data representing that display is started at the currently displayed page is recorded onto the recording medium when the contents of the recording medium 8 currently loaded in the slot 9 are displayed next (step #29), and an index image showing a bookmark is displayed so as to be superimposed on the currently displayed page (bookmarked page) on the image display 7 (step #30). Then, the process returns to the processing of step #24.

On the other hand, when a page switching instruction is not provided (NO at step #28), the amplitude (X1, Y1) of the vibration occurring on the electronic book 1 is detected (step #31), and the image is moved by (−X1, −Y1) so that the detected amplitude (X1, Y1) is canceled out (step#32). That is, the image being displayed on the image display 7 is moved in a direction opposite to the direction of the movement of the electronic book 1 due to a vibration by an amount substantially the same as the amount of the movement. The general controller 33 repeats the processing from steps #22 to #32 until the main power switch is turned off through the power switch 3.

As described above, since the display position of the image displayed on the image display 7 is moved in a direction opposite to the direction of the vibration occurring on the electronic book 1 by a movement amount substantially the same as the amplitude of the vibration, like in the above-described embodiment, when the user of the electronic book 1 is viewing an image, the display position of the image with respect to the user's line of sight can be maintained substantially fixed, so that like in the above-described embodiment, excellent viewability can be secured even when a vibration occurs on the electronic book 1.

[2] When a vibration occurs on the electronic book 1, in many cases, a vibration also occurs on the user holding the electronic book 1. Therefore, if the image display 7 and the display position of the image are moved by an amount completely the same as the amplitude of the vibration occurring on the electronic book 1, there is a possibility that the user feels a sense of difference in the viewability of the image. In this case, by moving the image display 7 and the image display position with respect to the vibration of the electronic book 1 by a movement amount slightly smaller than the amplitude of the vibration, the sense of difference can be reduced.

On the other hand, a case is considered where the vibration occurring on the electronic book 1 and the vibration of the user disaccord with each other. In that case, even if the image display 7 and the image display position are moved by an amount completely the same as the amplitude of the vibration occurring on the electronic book 1, the image display position with respect to the user's line of sight cannot be completely maintained fixed.

Therefore, for example, by detecting a swing (a vibration, a motion) of a part (particularly, the head) of the user's body and moving the image display 7 and the image display position in consideration of the detection result, the viewability of the image display 7 can be improved.

When an attachment (earphones, etc.) attached to a part (particularly, the head) of the user's body are included in addition to the apparatus body provided with the image display, by providing the attachment with the vibration detection sensor 5, it is necessary only to incorporate the vibration detection sensor 5 in the attachment and it is unnecessary to newly structure an attachment for detecting a swing (a vibration, a motion) of the part (particularly, the head) of the user's body, so that cost increase can be suppressed.

[3] The object of the art of this application is not limited to the electronic book 1, but is applicable to other electronic apparatuses, for example, portable communication apparatuses such as digital still cameras, game apparatuses, PDAs (personal digital assistants), mobile telephones and mobile computers that optically capture an image of the subject, convert the image into an electric signal by use of a semiconductor device and store it into a storage medium as digital data, and the image displays of in-car television systems and in-car navigation systems. In short, the art of this application is applicable to all apparatuses that are provided with an image display and frequently used under circumstances where vibrations are readily provided.

[4] Of the objects of application mentioned in the modification [3], for example, digital still cameras are sometimes provided with a shake detection sensor for reducing a blur of the captured image caused due to a camera shake. In this case, by using this shake detection sensor also for detecting the vibration in the first embodiment and the modification [1], the increase in the size and cost of the apparatus can be suppressed compared to when the vibration detection sensor 5 is provided separately from the shake detection sensor.

[5] The image displayed on the image display 7 is not limited to a mere string of letters, but the display image may be decorated by, for example, a picture of a book opened at a page or inserting an illustration in a part of the display area of the image display 7. Moreover, image data of letters and characters such as alphabetical letters, characters of each language or special characters may be stored for each font. The data may be previously recorded on the image storage of the recording medium 8 or the like.

While the data of the image and the like displayed on the image display 7 are obtained from the image storage 30 in the above-described embodiment, the present invention is not limited thereto. For example, a structure may be adopted such that a storage having a comparatively large storage capacity is provided in the electronic book 1, the electronic book 1 is structured so as to be capable of communicating with, for example, a personal computer, the data provided by the personal computer is stored in the storage, and when an instruction is provided by the user, the stored contents are read out from the storage and displayed on the image display 7.

[6] While in the above-described embodiment and modification [1], when the main power is turned on through the power switch 3, the motion of the electronic book 1 and the like is normally detected and the driving of the image display 7 and the change of the image display position are performed according to the detected motion of the electronic book 1, the present invention is not limited thereto. A structure may be adopted such that an execution mode to execute this operation and a non-execution mode not to execute the operation are provided, an operation portion such as a button for switching between these modes is provided and when the operation mode is selected through the operation portion, the driving of the image display 7 or the like is performed.

When the non-execution mode is selected, since it is unnecessary to drive the vibration detection sensor 5, the vibration detection processor 31, the actuators 17 and 18 and the like, power consumption can be reduced.

It is effective to select the non-execution mode when the electronic book 1 or the like is used while maintained stationary such as placed on a desk. Moreover, it is effective to select the non-execution mode when the main contents to be played back are sound (for example, music) and the displayed image is an accompaniment.

[7] In a case where the image display position is changed like in the above-described modification [1], the following situation can occur: For example, when a text such as a novel is displayed on the image display 7, if the image display position is moved in accordance with the vibration of the electronic book 1, the movement amount of the image display position is large when the amplitude of the vibration of the electronic book 1 is comparatively large, so that there are cases where the place to which the image display position is moved is beyond (outside) the display area of the image display 7.

In such a case, the image display position may be moved even if the image (for example, the contents of the novel) are partly interrupted, or the image display position may be moved within a range where the image is not interrupted. Further, a structure may be adopted such that the movement methods of the image display position are set as modes and these modes can be alternatively selected through a predetermined operation (a button, a switch, etc.).

The above-described apparatus is an image display apparatus provided with: a display that displays an image; a first detector that detects a vibration provided to the image display apparatus; and a display controller that moves a display position of the image displayed on the display in a direction opposite to a direction of a motion of the image display apparatus which motion constitutes the vibration detected by the first detector.

Moreover, the above-described method is an image display method in which when an image is displayed on a predetermined display, a vibration provided to the display is detected, and a display position of the image displayed on the display is moved in a direction opposite to a motion of the display which motion constitutes the detected vibration.

According to this apparatus or method, when a vibration provided to the image display apparatus or the display is detected, the image display position is moved in a direction opposite to the direction of the motion in the detected vibration. Consequently, when the user of the image display apparatus is viewing an image displayed on the display portion, even if a vibration is provided to the image display apparatus or the display, it is unnecessary for the user to move the line of sight or the movement amount of the line of sight is reduced.

Further, the above-described apparatus is provided with a second detector that detects a motion of a predetermined part of a body of a user of the image display apparatus, and the display controller moves the display position of the image displayed on the display by use of detection results of the first and second detectors.

According to this apparatus, when a motion of a predetermined part of the user of the image display apparatus is detected, the display position of the image displayed on the display screen of the display is moved based on the detected vibration of the image display apparatus and the motion of the predetermined part of the body.

For example, the following can be performed: When the user's body is substantially stationary, the display position of the image displayed on the display is moved in a direction opposite to the direction of the motion of the image display apparatus by an amount the same as the amplitude of the vibration of the apparatus, and when the user's body is also shaking by a predetermined amount, the movement amount of the display position of the image displayed on the display is set in consideration of the shake amount.

Consequently, more excellent viewability of the display in accordance with the motion of a predetermined part of the user's body is obtained. The predetermined part of the body is, for example, the head.

The above-described apparatus is an image display apparatus provided with: a display that displays an image; a driver that drives the display in a direction substantially parallel to a display screen of the display; a first detector that detects a vibration provided to the image display apparatus; and a driving controller that causes the driver to drive the display in a direction opposite to a direction of a motion of the image display apparatus which motion constitutes the vibration detected by the first detector.

Moreover, the above-described method is an image display method in which when an image is displayed on a predetermined display, a vibration provided to the display is detected, and the display is driven in a direction opposite to a motion of the display which motion constitutes the detected vibration.

According to this apparatus or method, when a vibration provided to the image display apparatus or the display is detected, the display is driven in a direction opposite to the direction of the motion by the detected vibration. Consequently, when the user of the image display apparatus is viewing an image displayed on the display, even if a vibration is provided to the image display apparatus or the display, it is unnecessary for the user to move the line of sight or the movement amount of the line of sight is reduced.

Further, in the above-described apparatus, the driver is provided with: a first and a second base member; a first holder that holds the second base member so as to be relatively movable in a first direction with respect to the first base member; a first actuator that drives the second base member in the first direction with respect to the first base member; a second holder that holds the display so as to be relatively movable in a second direction, different from the first direction, with respect to the second base member; and a second actuator that drives the display in the second direction with respect to the second base member.

According to this apparatus, the second base member is driven by the first actuator in the first direction with respect to the first base member and the display is driven by the second actuator in the second direction, different from the first direction, with respect to the second base member. Consequently, the display can be driven on a plane substantially parallel to the display screen of the display (along the display screen), so that the viewability of the image with respect to the vibration caused in a direction substantially parallel to the display screen can be improved.

Further, the above-described apparatus is provided with a second detector that detects a motion of a predetermined part of a body of a user of the image display apparatus, and the driving controller causes the driver to drive the display by use of detection results of the first and second detectors.

According to this apparatus, when a motion of a predetermined part of the user of the image display apparatus is detected, the display is driven by the driver based on the detected vibration of the image display apparatus and the motion of the predetermined part of the body.

For example, the following modes are considered: a mode in which the display is moved in a direction opposite to the direction of the motion of the image display apparatus by an amount the same as the amplitude of the vibration of the apparatus, and when the user's body is also shaking by a predetermined amount, the driving amount of the display is set in consideration of the shake amount.

Consequently, more excellent viewability of the display in accordance with the motion of a predetermined part of the user's body is obtained. The predetermined part of the body is, for example, the head.

Further, in the above-described apparatus, the first detector is an acceleration sensor that detects an acceleration of, of the motion of the image display apparatus which motion constitutes the vibration, a motion in a direction substantially parallel to a display screen of the display. Consequently, the acceleration of the motion in the direction along the surface on which the image is displayed is detected.

Moreover, the above-described apparatus is an electronic apparatus provided with an image display apparatus having the above-described various structures.

As described above in detail, the display position of the image displayed on the display is moved or the display is driven in a direction opposite to the motion of the image display apparatus or the display which motion constitutes a vibration provided to the image display apparatus or the display.

Consequently, when the user is viewing an image displayed on the display, even if a vibration is provided to the image display apparatus or the display, it is unnecessary for the user to move the line of sight or the movement amount of the line of sight is reduced, so that excellent viewability can be obtained even under circumstances where a vibration occurs on the user of the apparatus, the apparatus or the display.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An electronic apparatus comprising:
a display that displays an image;
a first detector that detects a vibration provided to the image display apparatus; and
a display controller that moves a display position of the image displayed on'the display in a direction opposite to a direction of a motion in the vibration of the image display apparatus detected by the first detector.

2. An electronic apparatus according to claim 1 further comprising:
a second detector that detects a motion of a predetermined part of a body of a user of the image display apparatus,
wherein the display controller moves the display position of the image displayed on the display by use of detection results of the first and second detectors.

3. An electronic apparatus according to claim 1,
wherein the first detector is an acceleration sensor that detects an acceleration of, of the motion of the image display apparatus which motion constitutes the vibration, a motion in a direction substantially parallel to a display screen of the display.

4. An electronic apparatus comprising:
a display that displays an image;
a driver that drives the display in a direction substantially parallel to a display screen of the display;
a first detector that detects a vibration provided to the image display apparatus; and
a driving controller that causes the driver to drive the display in a direction opposite to a direction of a motion in the vibration of the image display apparatus detected by the first detector.

5. An electronic apparatus according to claim 4,
wherein the driver comprises:
a first and a second base member;
a first holder that holds the second base member so as to be relatively movable in a first direction with respect to the first base member;
a first actuator that drives the second base member in the first direction with respect to the first base member;
a second holder that holds the display so as to be relatively movable in a second direction, different from the first direction, with respect to the second base member; and
a second actuator that drives the display in the second direction with respect to the second base member.

6. An electronic apparatus according to claim 4 further comprising:
a second detector that detects a motion of a predetermined part of a body of a user of the image display apparatus,
wherein the driving controller causes the driver to drive the display by use of detection results of the first and second detectors.

7. An electronic apparatus according to claim 4,
wherein the first detector is an acceleration sensor that detects an acceleration of, of the motion of the image display apparatus which motion constitutes the vibration, a motion in a direction substantially parallel to a display screen of the display.

8. An image display method for displaying an image on a display, the method comprising:
detecting a vibration of the display; and
moving a display position of the image displayed on the display in a direction opposite to a motion in the detected vibration of the display.

9. An image display method according to claim 8 further comprising:
detecting a motion of a predetermined part of a body of a user of the display,
wherein the display position of the image displayed on the display is moved by use of detection results of the vibration of the display and the motion of the predetermined part.

10. An image display method for displaying an image on a display, the method comprising:
detecting a vibration of the display; and
driving the display in a direction opposite to a motion in the detected vibration of the display.

11. An image display method according to claim 10 further comprising:
detecting a motion of a predetermined part of a body of a user of the display,
wherein the display is moved by use of detection results of the vibration of the display and the motion of the predetermined part.
